(19) United States
(12) Patent Application Publication
(10) Pub. No.: US 2023/0102152 A1
(43) Pub. Date: Mar. 30, 2023

(54) AUTOMATIC DETECTION OF CHANGES IN DATA SET RELATIONS

(71) Applicant: International Business Machines Corporation, Armonk, NY (US)

(72) Inventors: Eliran Roffe, Haifa (IL); Samuel Solomon Ackerman, Haifa (IL); Eitan Daniel Farchi, Pardes Hanna-Karkur (IL); Orna Raz, Haifa (IL)

(21) Appl. No.: 17/484,104

(22) Filed: Sep. 24, 2021

(51) Int. Cl. G06Q 10/06; G06F 16/215; G06K 9/62; G06F 11/34; G06N 20/00

(52) U.S. Cl. CPC G06Q 10/06375; G06F 16/215; G06K 9/6255; G06F 11/3428; G06N 20/00

(57) ABSTRACT

A system, program product, and method for automatic detection of data drift in a data set are presented. The method includes determining changes to relations in the data set through generating baseline and production data sets. The method further includes generating a production data set with some inserted data distortion, and defining, for a plurality of features in the baseline data set, potential relations for participant features. The method also includes determining a first likelihood and a second likelihood of each potential relation in the baseline and production data sets, respectively, for the participant features. The method further includes comparing each first likelihood with each second likelihood, generating a comparison value that is compared with a threshold value, and determining, subject to the comparison value exceeding the threshold value, the potential relation in the baseline data set does not describe a relation in the production data set.

### BACKGROUND

The present disclosure relates to automatic detection of data quality issues, and, more specifically, to automatic detection of changes in data set relations.

Many known systems experience quality changes to the data maintained therein over time, where such quality changes may include data quality degradation, e.g., data drift.

### SUMMARY

A system, computer program product, and method are provided for automatic detection of data quality issues.

In one aspect, a computer system is provided for automatic detection of data quality issues. The system includes one or more processing devices and one or more memory devices communicatively and operably coupled to the one or more processing devices. The system also includes a data drift determination tool at least partially resident within the one or more memory devices. The data drift determination tool is configured to determine, in real-time, an indication of one or more changes to one or more relations in a baseline data set. The data drift determination tool is also configured to provide a production data set. The baseline data set and production data set are at least partially representative of the same domain. The production data set includes at least some data distortion. The data drift determination tool is further configured to define, for a plurality of participant features in the baseline data set, one or more potential relations. The data drift determination tool is also configured to determine a first likelihood of each potential relation of the one or more potential relations in the baseline data set and determine, for the participant features, a second likelihood of each potential relation of the one or more potential relations in the production data set. The data drift determination tool is further configured to compare each first likelihood with each second likelihood, thereby generating one or more comparison values, and compare the one or more comparison values with one or more respective threshold values. The data drift determination tool is also configured to determine, subject to the one or more comparison values exceeding the one or more respective threshold values, the one or more potential relations in the baseline data set do not describe a relation in the production data set.

In another aspect, a computer program product embodied on at least one computer readable storage medium having computer executable instructions for automatic detection of data quality issues in a baseline data set that when executed cause one or more computing devices to determine, in real-time, an indication of one or more changes to one or more relations in the baseline data set. The computer executable instructions when executed also cause the one or more computing devices to provide a production data set. The baseline data set and the production data set are at least partially representative of the same domain. The production data set includes at least some data distortion. The computer executable instructions, when executed, also defines, for a plurality of participant features in the baseline data set, one or more potential relations. The computer executable instructions when executed further cause the one or more computing devices to determine a first likelihood of each potential relation of the one or more potential relations in the baseline data set, and determine a second likelihood, for the participant features, of each potential relation of the one or more potential relations in the production data set. The computer executable instructions when executed also cause the one or more computing devices to compare each first likelihood with each second likelihood, thereby generating one or more comparison values, and compare the one or more comparison values with one or more respective threshold values. The computer executable instructions when executed further cause the one or more computing devices to determine, subject to the one or more comparison values exceeding the respective one or more respective threshold values, the one or more potential relations in the baseline data set does not describe a relation in the production data set.

In yet another aspect, a computer-implemented method is provided for automatically detecting data quality issues. The method includes determining, in real-time, an indication of one or more changes to one or more relations in baseline data set. The method also includes providing a production data set. The baseline data set and the production data set are at least partially representative of the same domain, and the production data set includes at least some data distortion. The method further includes defining, for a plurality of participant features in the baseline data set, one or more potential relations. The method also includes determining a first likelihood of each potential relation of the one or more potential relations in the baseline data set, and determining, for the participant features, a second likelihood of each potential relation of the one or more potential relations in the production data set. The method further includes comparing each first likelihood with each second likelihood, thereby generating one or more comparison values, and comparing the one or more comparison values with one or more respective threshold values. The method also includes determining, subject to the one or more comparison values exceeding the one or more respective threshold values, the one or more potential relations in the baseline data set do not describe a relation in the production data set.

The present Summary is not intended to illustrate each aspect of, every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1 is a block schematic diagram illustrating a computer system configured for automatically detecting data quality issues, in accordance with some embodiments of the present disclosure.

FIG. 2A is a flowchart illustrating a process for automatically detecting data quality issues, in accordance with some embodiments of the present disclosure.

FIG. 2B is a continuation of the flowchart shown in FIG. 2A, in accordance with some embodiments of the present disclosure.

FIG. 3 is a block schematic diagram illustrating at least a portion of the objects acted upon in FIGS. 2A and 2B, in accordance with some embodiments of the present disclosure.

FIG. 4 is a graphical diagram illustrating behavior of a Bayes Factor as a function of a percentage of data shuffling for a first use case, in accordance with some embodiments of the present disclosure.

FIG. 5 is a graphical diagram illustrating behavior of a Bayes Factor as a function of a percentage of data shuffling for a second use case, in accordance with some embodiments of the present disclosure.

FIG. 6 is a block schematic diagram illustrating a computing system, in accordance with some embodiments of the present disclosure.

FIG. 7 is a schematic diagram illustrating a cloud computing environment, in accordance with some embodiments of the present disclosure.

FIG. 8 is a schematic diagram illustrating a set of functional abstraction model layers provided by the cloud computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to automatic detection of data quality issues. While the present disclosure is not necessarily limited to such applications, various aspects of the disclosure may be appreciated through a discussion of various examples using this context.

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Many known systems experience quality changes to the data maintained therein, where such quality changes may include data quality degradation in the form of data drift. Such data drift extends beyond data quality degradation such as, and without limitation, mere data corruption, mis-indexed data, and data entry errors. Rather, more specifically, such data drift extends to data, and the relationships between the data, that change over a period of time. In at least some instances of data drift, the changes are difficult to detect. In addition, some instances of data drift may be more or less important than other instances. Therefore, detection of data drift and remediation efforts may be time-consuming and resource-intensive, and such changes may not be identifiable, even through employment of individuals with domain expertise. Regardless of the exact nature of the data drifts, data quality and data coherency remain as significant concerns in the respective data sets.

In some embodiments of large data sets, the more mature data sets may include data and data relations that have become outdated or irrelevant with the passage of time. For example, and without limitation, for at least some data-based models of mobile phone configurations used for predicting the pricing of the devices, both physical characteristics and software features typically found in mobile phones ten years ago are drastically different from those physical characteristics and software features typically found in most modern mobile phones due to the rapid advancement of the respective technologies. In some instances, advancements to the keyboard emulations include changes to the touch keys, where the changes may be subtle and/or proprietary; however, such changes may not have been captured through an updated model. Therefore, any associated changes with respect to the pricing of the device directly associated with the touch keys will have been missed. Further, in some instances, there may be thousands of changes to the mobile phones within a particular brand, and the previous example may be extrapolated to significant monetary values.

Moreover, some changes may be more important than other changes. For example, the aforementioned changes to the touch keys may include changes that are operationally important to the user and some changes may be merely aesthetic in nature, e.g., the color scheme for the touch key screens. In such cases, where the modeler desires to capture all of the changes to such devices, a mobile phone domain expert may be employed to determine, possibly, most of the undocumented historical changes to the mobile phones over the years such that the pricing of the various models may be more accurately reflective of the present physical characteristics and software features. However, capturing all of the changes in this manner, whether the changes be of greater or lesser importance relative to each other, may not be practical. Therefore, at least some changes, regardless of importance to the pricing of the respective models, will not be identified, thereby resulting in possible device overpricing or underpricing for the present market.

Further, some embodiments of aging data sets that include data and data relations that have become outdated or irrelevant with the passage of time may include, e.g., human resource databases or models used to predict compensation packages for specific skill sets, e.g., those skills typically associated with application developers. For example, for at least some of such models, the resident static data associated with the compensation for once new, but now mature, applications, e.g., Hypertext Preprocessor (PHP) (a general-purpose scripting language suitable for web development that was first introduced in 1995) may be less desirable in the present than in the past in view of skills in the more modern Online Go Server (OGS) and React (an open-source front-end JavaScript library). Accordingly, the compensation packages and the resource searches for certain developer skills may not be commensurate with the present skills-hiring landscapes, where opportunities to acquire individuals with certain talents may be negatively impacted.

Moreover, in some embodiments, for large relational databases, the relationships between at least a portion of the data may change with time. For example, considering embodiments such as an equipment lubrication database for an industrial facility, relationships between the lubricated equipment and the lubricants will evolve outside of the associated database as equipment comes and goes and lubricant formulations and brands come and go. Specifically, as an example of upstream process changes, certain equipment using a specialized lubricant may be removed and equipment using another lubricant may be installed in its place. Therefore, the relationship within the relational database between the lubricated equipment and the respective lubricants will experience data drift which is a natural result of the database lagging the real world. Results may include automatic reordering of no-longer-necessary lubricants and incomplete or erroneous information available to the lubricating technicians. Other examples of upstream process changes include sensors being replaced that change the units of measurement from inches to centimeters. Additional data drift issues include a broken sensor consistently transmitting a zero reading and natural drift in the data, such as the mean temperature of a region that changes with the seasons. Accordingly, data drift due to changing data relationships may have financial implications in a variety of economic and technical sectors.

In addition, in embodiments that include more modern data sets, the relationships between the data may be well documented. However, for more mature legacy systems, such relationships may not have been documented. Furthermore, for some instances of data drift, unlike the previous examples where the relationships are not difficult to find, some data may have more obscure relationships that may be much harder to discern, even through employment of individuals with the respective domain expertise. Accordingly, identification of the changes to specific relations between data facilitates identification of the associated data drift; however, such identification may not be easily or financially feasible.

In some embodiments, even if the relationships between the data are determined, it is sometimes difficult to identify the strength of each of the determined relationships, i.e., there is no definition of a threshold that defines a separation between strong and weak relations. Also, since there is not a global threshold for all data sets, any thresholds will need to be determined for a particular data set based on the data content, data attributes, and data usage. However, many known database analytics do not have a mechanism to determine the strength between the data relationships and any attempts to recover for data drift may be hampered through lack of knowledge of what relationships are more important than others based on their respective strengths.

A system, computer program product, and method are disclosed and described herein for automatic detection of data quality issues, and, more specifically, to automatic detection of changes in data set relations through at least data quality degradation, e.g., data drift. The system, computer program product, and method are configured to determine a correlation between features of the data in the respective data sets. Such data set features are variables that are defined and used as described further herein; however, in some embodiments, the features of a data set are equivalent to the columns that at least partially define the data set. In some embodiments, the features are not necessarily characteristics or values of the data itself. The identified data set features are used to identify potential relations between the respective data set features, where such features used to identify the potential relations are referred to herein as participant features, where the participant features used to determine differences between relations between two data sets are distinguished from those features that are not used. In addition, the influence of artificially introduced changes to the relations of the participant features in the respective data sets is determined through applying some combination of machine learning techniques and statistical techniques, e.g., and without limitation, linear regression, linear likelihood, and Bayes factor analyses. In addition, feedback of the automated analyses, collected during previous applications of one or more of the embodiments described herein, may also be injected into the present analyses to locate the data quality issues residing in the respective data sets. For example, and without limitation, relations that were previously demonstrated to have drifted may be used as “strong” indicators, even if they did not initially demonstrate sufficient statistical evidence for such designation. Accordingly, specific feature combinations that have changed in the past may be weighted by the users to facilitate attainment of certain results.

Moreover, in at least some embodiments, human feedback may be utilized to more rapidly train the respective machine learning models as well as improve the quality of the present analyses. The human feedback includes, without limitation, identifying those features to determine the relations, and identifying whether or not a given relation is important for analyzing the data set for data drift, and if the respective relation is important for the purposes associated with the employment of the data set. Therefore, for some embodiments described herein, the system, computer program product, and method disclosed herein are configured for automatically determining the influence of changes in the data set among the relations. Moreover, for at least some of the embodiments described herein, thresholds may be established for automatically identifying those relations that have changes sufficient to warrant further analysis. Furthermore, the system, computer program product, and method disclosed herein are configured to subsequently automatically select those relations that are effective in detecting the changes to the data set of interest that may have been introduced through the aforementioned data drift. More specifically, many of the embodiments described herein are configured to determine the relative strength of the affected relations such that those relations with stronger relations may receive more analytical scrutiny than those relatively weak relations. Accordingly, the relations which are determined as strong will be helpful for identifying the changes in the data set.

In one or more embodiments, an initial, i.e., baseline data set is provided. In some embodiments, the entire baseline data is used as described further herein. In some embodiments, the data elements selected for the baseline data set are either selected automatically at least partially based on predetermined criteria, or selected manually, also at least partially based on respective criteria. In some embodiments, the baseline data set may be pruned to improve the respective data set. In some embodiments, the baseline data set is used to train the respective machine learning (ML) model that is being configured to be placed into production to identify the relations between the data features as described herein. In some embodiments, the baseline data set is used to perform the first round of statistical analytics to generate a baseline statistical model configured to identify the relations between the data features as described herein. Accordingly, the baseline data set is used to establish one or more baseline ML models and one or more baseline statistical models that will be used to facilitate early detection of changed relations, i.e., data drift between the features of new data records in a production data set and the initial data records in the baseline data set.

In at least some embodiments, a test data set, herein referred to as a production data set, is created. In some embodiments, the records of the production data set are new records collected subsequent to the baseline data set that are at least partially, and preferably, are substantially in the same domain as the baseline data set. In some embodiments, all of the subsequent records of the production data set are used further as described herein. In some embodiments, particular records are selected for, or pruned from, the production data set in a manner similar to that for the baseline data set as described further herein.

In some embodiments, once the baseline ML model and the baseline statistical model are generated, the production data set is applied to the respective models to determine if there are relations between the participant features that may be different between the production data set and the relations in the baseline data set. In general, since the records in the baseline and production data sets are in the same domain, there may not be significant differences between the relations in the two data sets regardless of the data values in the records. In other words, in some embodiments, the relations found in one data set could be substantially identical to the relations found in the other data set. However, if significant differences are identified in one data set over the other data set, either there may be issues with the baseline data set; there may be issues with either the ML model or the statistical model, i.e., they may be either erroneously trained or otherwise misconfigured; or a relation may exist in the first data set that does not exist in the second data set, or vice versa; or something may be inherently wrong with the analytical technique being applied. Accordingly, as discussed further herein, the system, computer program product, and method disclosed herein are directed toward determining differences between relations between the first and second data sets.

In some embodiments, for the production data set a specific number of changes of specific categories are inserted into the production data set. Some of the specific categories include changes that emulate data drift and changes that emulate noise. For example, and without limitation, selected data elements (i.e., data cells) resident within one or more particular columns, where each column represents a participant feature, may be switched between specific records, or automatically and randomly within a specified percentage of data records. In some embodiments, the order of the data in selected columns (for those participant features and relations of interest) is maintained constant; however, the surrounding data in a particular row is switched with the data in another row. Accordingly, the effect of emulating data drift includes rearranging some of the data associated with a particular, i.e., participant feature with a known relationship so that the respective relations are changed or potentially changed.

For example, and without limitation, for those embodiments where a data set includes two data columns that define a relation between salary and hours worked for employees, the hours data for two records in the hours column are swapped with each other, where the remainder of the data in the respective two records remains static. The hours-salary relationship, i.e., relation for the participant features for these two records are altered with respect to their previous relationship and the relationship between the remainder of the untouched records. The percentage of each column to be altered may be altered from test analysis-to-test analysis. The strength of the relation to be altered may also be changed for each analytic cycle. In addition, the number of the columns, i.e., participant features to be altered may be altered from test-to-test.

Furthermore, in some embodiments, data is removed from a predetermined percentage of the cells in the selected columns to simulate missing values. Alternatively in some embodiments, some of the data may be replaced with “dummy data” that is known to not be sensible data as defined through the totality of the data originally resident within the column. Moreover, in some embodiments, the respective data may be generated and inserted randomly without previous knowledge by the human users to minimize a potential for inadvertent bias introduction through systematic value substitutions and to determine the performance of the system described herein to abrupt and unexpected changes in relations. Therefore, in some embodiments, the production data set has a different set of relations between the same participant features as compared to the established and identified relations of the baseline data set, where the newly established relations have different coefficients that those of the baseline data set. Accordingly, the change to established relations is simulated through known data feature changes, and the subsequent effects are determined and analyzed to facilitate detecting future changes to the respective relations through organically-occurring data drift, in contrast to artificially-created data drift.

In one or more embodiments, the features, i.e., columns of the baseline data set are assigned a variable, e.g., “Z.” The features associated with the variable Z, i.e., the other columns, have been previously correlated such that the correlations between Z and the most correlated features in the baseline data set are known. The most correlated features in the baseline data set are assigned the terms X₁ through Xₙ, where n is a predefined value. A potential relation based on the variable Z and its most correlated features X₁ through Xₙ is defined. A polynomial equation including the variable Z and the most correlated features X₁ through Xₙ is established, and the polynomial equation is solved for both the baseline data set and the production data set. More specifically, the likelihood of the potential relation being an actual substantive relation is determined for each of the baseline data set and the production data set. The likelihood for the baseline data set is expressed as L_{Baseline} and the likelihood for the production data set is expressed as L_{Production}. Accordingly, the modeled production data set and the model for the baseline data set are compared.

The two likelihoods are compared to each other through a Bayes Factor analysis that is defined by the expression B₁₀=P(Substantive Relation|D_{Production})/P(Substantive Relation|D_{Baseline}), where B₁₀ represents a comparison value, i.e., a Bayes Factor; D_{Production} represents the data in the production data set; P(Substantive Relation|D_{Production}) represents the probability that the potential relation is a substantive relation in the production data set, i.e., L_{Production}; D_{Baseline} represents the data in the baseline data set; and P(Substantive Relation|D_{Baseline}) represents the probability that the potential relation is a substantive relation in the baseline data set, i.e., L_{Baseline}. The Bayes Factor is determined by comparing the likelihoods between the two data sets and expresses how much better the data fits the baseline data set compared to the production data set. The baseline factor is compared to an established threshold such that if the calculated Bayes Factor exceeds the threshold, there is a significant change in the subject relation such that the baseline models no longer describe the relationship between the features in the production data set.

In some embodiments, a fixed percentage “p” of the data in a particular column of a production data set was shuffled with respect to the respective rows through a set of values for p ranging from 0 (no data shuffling) and 1 (respective column data for all rows shuffled). An initial threshold (T) for the Bayes Factor B₁₀ is T=3. This initial threshold may be adjusted later at least partially as a function of the following analyses. The thresholds used for the Bayes Factor analyses as described herein are unique values determined for the specific data sets being analyzed and are different from the Bayes Factor thresholds typically determined through standard use of the Bayes algorithm. For strong relations, the expected behavior of the Bayes Factor is for the value to increase as the distortion induced in the shuffled data increases through the increased data alteration (i.e., increased p). In addition, the likelihood of the proposed relation being substantive increases for the production data set through increased data alteration faster than the likelihood of the proposed relation being substantive increases for the baseline data set. The Bayes Factor changed rapidly such that the threshold value T=3 was quickly exceeded as the value of p increased from 0 to 1. In contrast, the expected behavior of the Bayes Factor for weak relations is for the value to be approximately unity to indicate that changing the percentage of the data alteration has no effect on the production data set as compared to the static baseline data set. Therefore, the calculated Bayes Factor is more affected through data drift for strong relations and the greater size of the affected data than data drift for weak relations regardless of the size of the affected data. Accordingly, use of the Bayes Factor analysis as described herein facilitates determining if data drift is, or is not, present, determining the strength of the relations, and correlating the amount of data drift with the threshold values for such data drift.

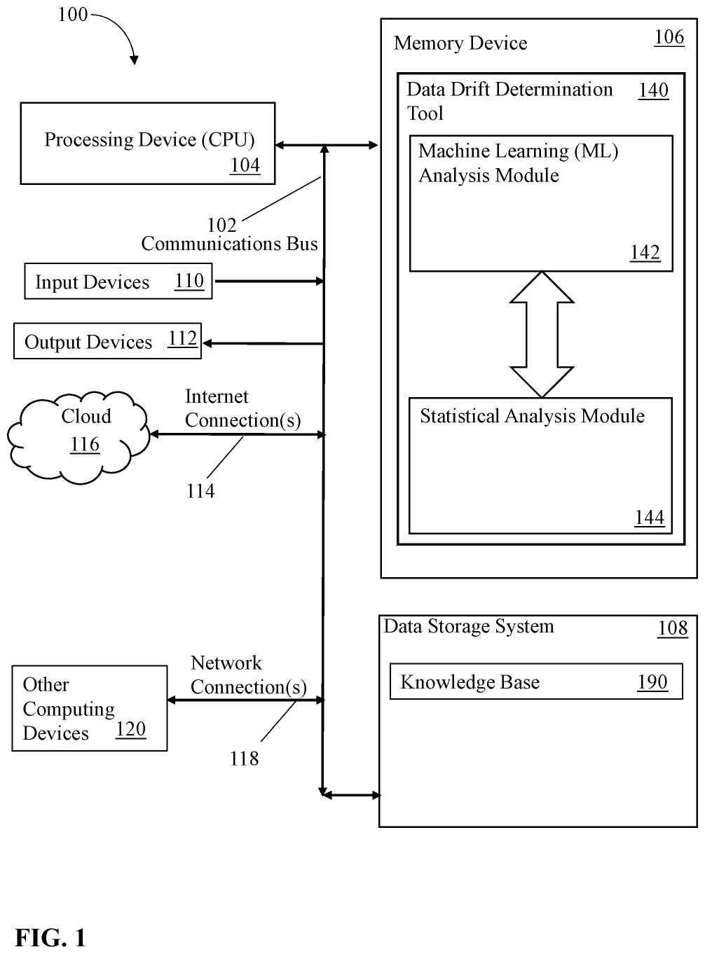

Referring to FIG. 1, a block schematic diagram is presented illustrating a computer system, i.e., an automated data quality issues detection system 100 (herein referred to as “the system 100”) that is configured automatic detection of data quality issues, and, more specifically, to automatic detection of changes in data set relations, in accordance with some embodiments of the present disclosure. The system 100 includes one or more processing devices 104 (only one shown) communicatively and operably coupled to one or more memory devices 106 (only one shown) through a communications bus 102, and in some embodiments, through a memory bus (not shown). The processing device 104 is a multicore processing device. The system 100 also includes a data storage system 108 that is communicatively coupled to the processing device 104 and memory device 106 through the communications bus 102. The system 100 further includes one or more input devices 110 and one or more output devices 112 communicatively coupled to the communications bus 102. In addition, the system 100 includes one or more Internet connections 114 (only one shown) communicatively coupled to the cloud 116 through the communications bus 102, and one or more network connections 118 (only one shown) communicatively coupled to one or more other computing devices 120 through the communications bus 102. In some embodiments, the Internet connections 114 facilitate communication between the system 100 and one or more cloud-based centralized systems and/or services (not shown in FIG. 1).

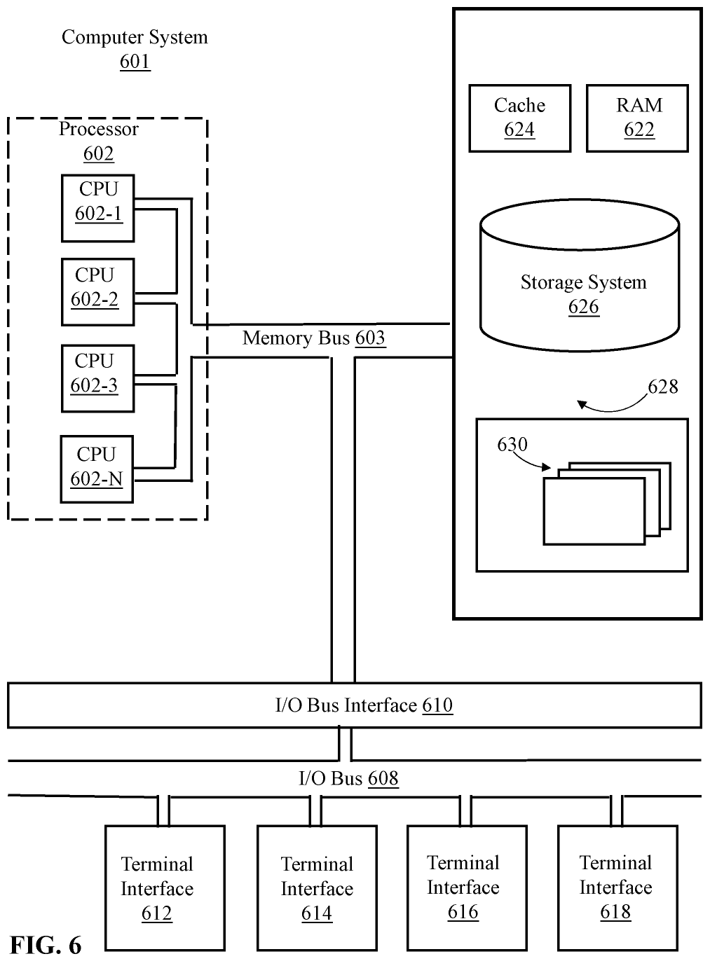

In at least some embodiments, the system 100 is a portion of a cloud computing environment (see FIG. 6), e.g., and without limitation, system 100 is a computer system/server that may be used as a portion of a cloud-based systems and communications environment through the cloud 116 and the Internet connections 114. In one or more embodiments, a data drift determination tool 140, herein referred to as “the tool 140”, is resident within the memory device 106 to facilitate automatic detection of data quality issues, and, more specifically, automatic detection of changes in data set relations. Accordingly, the tool 140 resident in the memory device 106 is configured to run continuously to run in the background to automatically determine data drift of a data set through determining changes in the relations of the data in the respective data sets.

In one or more embodiments, the tool 140 includes a machine learning (ML) analysis module 142 and a statistical analysis module 144 in communicative and operable communication with each other to execute the method steps as described further herein. In at least some embodiments, the data storage system 108 provides storage to, and without limitation, a knowledge base 190 that includes, without limitation, the data sets as described further herein.

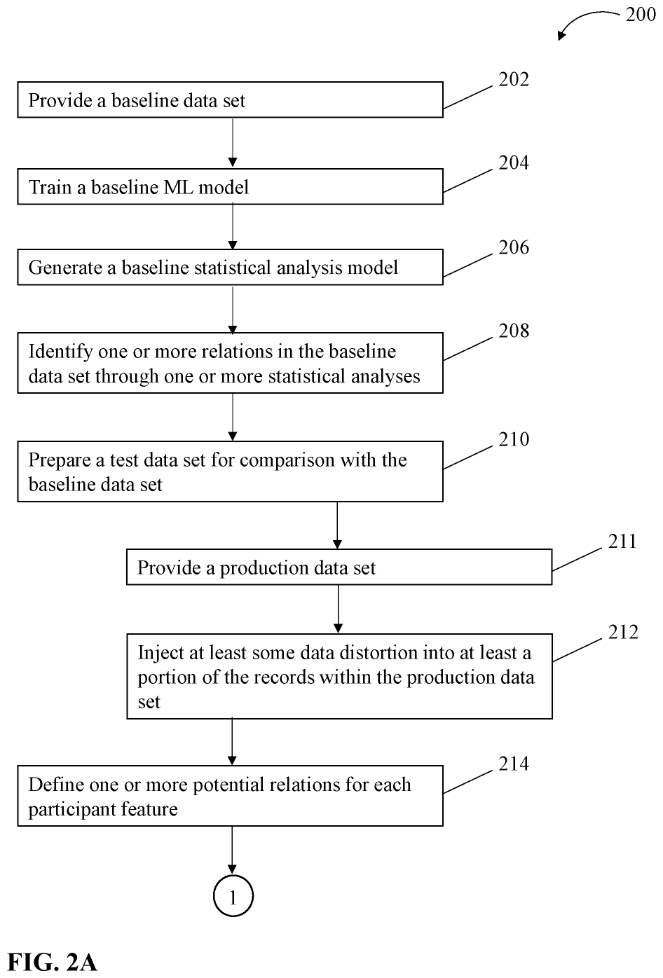

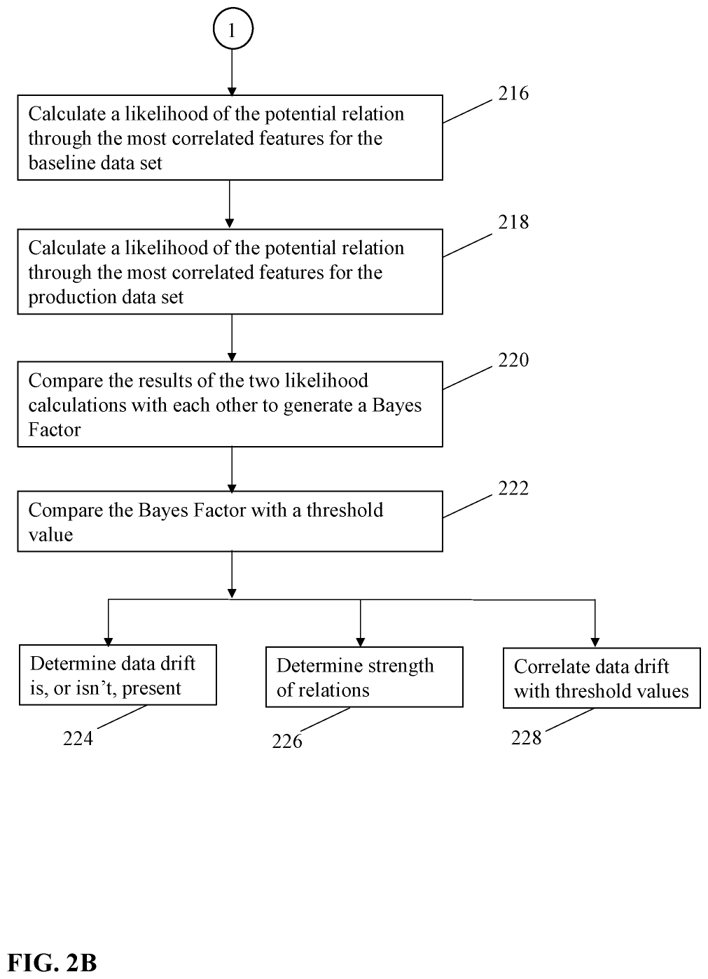

Referring to FIGS. 2A and 2B, a flowchart is presented illustrating a process 200 for automatically detecting data quality issues, in accordance with some embodiments of the present disclosure. Also referring to FIG. 3, a block schematic diagram 300 is presented illustrating at least a portion of the objects acted upon in FIGS. 2A and 2B, in accordance with some embodiments of the present disclosure. In one or more embodiments, a baseline data set 312 is provided through the knowledge base 190 resident in the data storage system 108. The baseline data set 312 includes a plurality of horizontal rows 314, or records 314, and a plurality of vertical columns 316, or features 316. Each record 314 includes a plurality of cells 318 that include data and define an intersection between the respective horizontal row 314 and the respective column 316. While the baseline data set 312 is shown as a small flat database, the illustration in FIG. 3 is non-limiting and any data set in any configuration (flat, relational, etc.) or size with any data that enables operation of the system 100 and the process 200 as described herein is used.

In some embodiments, the data elements, i.e., the records 314 selected for the baseline data set 312 are either selected automatically at least partially based on predetermined criteria, or selected manually, also at least partially based on respective criteria. In some embodiments, the baseline data set 312 is pruned to improve the baseline data set 312. For example, and without limitation, the records 314 for the baseline data set 312 are selected through random selection of the rows 314 either automatically or manually. In some embodiments, the baseline data set 312 is used to train 204 the respective machine learning (ML) model 310 (resident in the ML analysis module 142) that is configured to be placed into production to identify the relations between the data features as described herein. In some embodiments, the baseline data set 312 is used to perform the first round of statistical analytics to generate 206 a baseline statistical analysis model 320 (resident in the statistical analysis module 144) configured to identify the relations between the data features as described herein.

The baseline ML model 310 and the baseline statistical analysis model 320 are configured to be communicatively and operably coupled to each other through the respective ML analysis module 142 and statistical analysis module 144 to share the computational and analytical steps as described herein. For those steps and operations that are clearly performed by one or the other, the appropriate model 310 or 320 will be identified. For those steps and operations where either of the two models 310 and 320 would be able to perform them due to overlapping features of the models 310 and 320, no particular model is identified.

In some embodiments, as the baseline statistical model 320 is generated 206, the baseline data set 312 is analyzed through the baseline statistical analysis model 320. Through such statistical analyses, such as, and without limitation, linear regression techniques and linear likelihood techniques (i.e., maximum likelihood estimation, or MLE), one or more correlations between the data records 314 in the baseline data set 312 may be established to further be leveraged in determining the relations between the features 316. In some embodiments, the baseline machine learning model 310 is trained through the baseline data set 312 to perform the aforementioned statistical analyses to identify the relations between the features 316 in the baseline data set 312. According, through either, or both, of the baseline ML model 310 and the baseline statistical analysis model 320, one or more relations in the baseline data set 312 are identified 208 thorough one or more statistical analyses, and the respective models 310 and 320 are ready for use to compare a production data set 322 with the baseline data set 312.

In one or more embodiments, once the baseline machine learning model 310 is trained 204 and the baseline statistical analysis model 320 is generated 206, and the relations between features of the baseline data set 312 have been identified 208, a production data set 322 is prepared 210 for comparison with the baseline data set 312 to determine if there are relations between the participant features 326 that may be different between the production data set 322 and the relations for the same participant features 316 in the baseline data set 312. Therefore, in some embodiments, initially, the production data set 322 is provided 211 through, without limitation collection of new data records 324 that are at least partially, and preferably, substantially in the some domain as the records 314 in the baseline data set 312. The production data records 324 may be provided through similar processes as described for the baseline data set 322, i.e., manual or automatic selection and pruning. In general, there should not be significant differences between the relations in the two data sets 312 and 322 regardless of the data values 318 and 328 in the respective records 314 and 324. In other words, the relations found in one data set should be substantially identical to the relations found in the other data set for the same participant features due to the records 314 and 324 being associated with the same domain. However, if significant differences are identified in one data set over the other data set, there may be issues with the baseline data set 312; there may be issues with either the ML model 310 or the statistical model 320, i.e., they may be either erroneously trained or otherwise misconfigured; or a relation may exist in the production data set 322 that does not exist in the baseline data set 312, or vice versa; or something may be inherently wrong with the analytical technique being applied. Accordingly, as discussed further herein, the tool 140 and process 200 as disclosed herein are directed toward determining differences between relations between the baseline data set 312 and the production data set 322.

In some embodiments, for the production data set 322, subsequent to the establishment of the production data set 322, at least some data distortion is inserted 212 into the production data set 322. More specifically, at least a portion of the records 324 within the production data set 322 are altered to generate the production data set 322 that will used in the following comparisons activities. Therefore, once the distortions are introduced, the production data set 322 includes the records 324 and participant features 326 with the selected data 328 changed. A specific number of changes of specific categories are inserted into the production data set 322. Some of the specific categories include changes that emulate data drift and changes that emulate noise. For example, and without limitation, selected data elements (i.e., data cells 328) resident within one or more particular columns 326, where each column represents a feature 326, and the selected columns represent the participant features 326, may be switched between specific records 324, or automatically and randomly within a specified percentage of data records 324. In some embodiments, the order of the data 328 in selected columns 326 (for those participant features and relations of interest) is maintained constant; however, the surrounding data 328 in a particular record 324 is switched with the data 328 in another record 324. Accordingly, the effect of emulating data drift includes rearranging some of the data 328 associated with a particular, i.e., participant feature with a known relationship so that the respective relations are changed or potentially changed.

For example, and without limitation, for those embodiments where the production data set 322 includes two data columns 326 that define a relation between salary and hours worked for employees, the hours data for two records 324 in the hours column 326 are swapped with each other, where the remainder of the data in the respective two records 324 remains static. Therefore, as a result of the data distortion injected 212 into the production data set 322, the hours-salary relationship for these two records 324 are altered with respect to their previous relationship and the relationship between the remainder of the untouched records 324. The percentage of each column 326 to be altered may be altered from test analysis-to-test analysis. The strength of the relation may also be altered for each analytic cycle. In addition, the number of the columns 326 to be altered may be altered from test-to-test.

Furthermore, in some embodiments, data is removed from a predetermined percentage of the cells 328 in the selected columns 326 to simulate missing values. Alternatively in some embodiments, some of the data 328 may be replaced with “dummy data” that is known to not be sensible data as defined through the totality of the data 328 originally resident within the column 326. Furthermore, in some embodiments, the respective data may be generated and inserted randomly without previous knowledge by the human users to minimize a potential for inadvertent bias introduction through systematic value substitutions and to determine the performance of the system 100 described herein to abrupt and unexpected changes in relations. Therefore, in at least some embodiments, at least a portion of a production data set 322 receives inserted distortions to generate a data set that will be used for testing purposes. There are number of mechanisms for such distortion insertions, with a few mechanisms described above. Any mechanism for generating distortions in the production data set 322 may be used that enables operation of the system 100, the tool 140, and the process 200 as described herein.

Accordingly, the change to established relations is simulated through known data feature changes, and the subsequent effects are determined and analyzed to facilitate detecting future changes to the respective relations through organically-occurring data drift, in contrast to the artificially-created data drift established to test the models 310 and 320 as described herein.

In one or more embodiments, the features, i.e., columns 316 of the baseline data set 312 are assigned a variable, e.g., “Z.” The features associated with the variable Z, i.e., the other columns 316, have been previously correlated such that the correlations between Z and the most correlated features in the baseline data set 312 are known. The most correlated features in the baseline data set 312 are assigned the terms X₁ through Xₙ, where n is a predefined value. A potential relation based on the variable Z and its most correlated features X₁ through Xₙ is defined 214 for the respective participant feature 316. A polynomial equation including the variable Z and the most correlated features X₁ through Xₙ is established. Typically, the number of correlated features is small, e.g., and without limitation, 2. Thus, for example, the variable Z is the target and the two most correlated features are X₁ and X₂. A maximum degree (i.e., exponent) allowed is specified, also typically 2, i.e., a second degree polynomial equation is to be solved. All the combinations of the correlated features X₁ and X₂ are considered up to the second degree. Again, for example, this would include X₁ and X₂ (single, or first, degree), X₁² and X₂², and X₁*X₂ (which is a second degree interactive expression). Accordingly, for the present example, the polynomial equation is a quadratic equation that defines a regression model of the variable Z on the terms X₁, X₂, X₁², X₂², and X₁*X₂.

The polynomial regression equation is solved for the baseline data set 312, through the most correlated features X₁ through Xₙ, to calculate 216 the likelihood of the potential relation being an actual substantive relation for the baseline data set 312 that is expressed as L_{Baseline}. Referring to FIG. 2B, which is a continuation of the process 200 from FIG, 2A, and continuing to refer to FIGS. 2A and 3, similarly, the polynomial equation is solved for the production data set 322, through the most correlated features X₁ through Xₙ, to calculate 218 the likelihood of the potential relation being an actual substantive relation for the baseline data set 312 that is expressed as L_{Production}.

In at least some embodiments, the two likelihoods are compared 220 to each other through a Bayes Factor analysis that is defined by the expression B₁₀=P(Substantive Relation|D_{Production})/P(Substantive Relation|D_{Baseline}), where B₁₀ represents the Bayes Factor; D_{Production} represents the data in the production data set 322; P(Substantive Relation|D_{Production}) represents the probability that the potential relation is a substantive relation in the production data set 322, i.e., L_{Production}; D_{Baseline} represents the data in the baseline data set 312; and P(Substantive Relation|D_{Baseline}) represents the probability that the potential relation is a substantive relation in the baseline data set 312, i.e., L_{Baseline}. The Bayes Factor is determined by comparing the likelihoods between the two data sets 312 and 322 and expresses how much better the data fits the baseline data set 312 compared to the production data set 322. The Bayes Factor is compared 222 to an established threshold value such that if the calculated Bayes Factor exceeds the threshold value, there is a significant change in the subject relation such that either, or both, the baseline ML model 310 and the baseline statistical analysis model 320 no longer describe the relationship between the participant features in the production data set 322.

In some embodiments, a fixed percentage “p” of the data in a particular column for the participant features of the production data set 322 are changed with respect to the respective records 324 through a set of values for p ranging from 0 (no data shuffling) and 1 (respective column data for all records shuffled) to generate a series of production data sets 322. In at least some embodiments, an initial threshold (T) for the Bayes Factor B₁₀ is T=3, where the numeral 3 is non-limiting and the initial threshold value for the Bayes Factor is any value that enables operation of the system 100, the tool 140, and the process 200 as described herein. This initial threshold value may be adjusted later at least partially as a function of the following described analyses, as well as subsequent analyses thereafter. The threshold values used for the Bayes Factor analyses as described herein are unique values determined for the specific data sets being analyzed and are different from the Bayes Factor thresholds typically determined through standard use of the Bayes algorithm. For strong relations, the expected behavior of the Bayes Factor is for the value to increase as the distortion induced in the production data set 322 increases through the increased data alterations (i.e., increased p). In addition, the likelihood of the proposed relation being substantive increases for the production data set 322 through increased data alteration faster than the likelihood of the proposed relation being substantive increases for the baseline data set.

In some embodiments, the Bayes Factor changes rapidly such that the threshold value T=3 is quickly exceeded as the value of p increases from 0 to 1. In contrast, the expected behavior of the Bayes Factor for weak relations is for the value to consistently to be approximately unity to indicate that changing the percentage of the shuffling has no effect on the production data set 322 as compared to the static baseline data set 312. Therefore, the calculated Bayes Factor is more affected through data drift for strong relations and the greater size of the affected data than data drift for weak relations regardless of the size of the affected data. This set of analyses facilitates determining the proper threshold values for a wide range of data drift conditions for each baseline data set 302. Therefore, the respective threshold values at least partially define the relative strength of each relation of the plurality of relations. Accordingly, use of the Bayes Factor analysis as described herein facilitates determining 224 if data drift is, or is not, present through automatic detection of changes in data set relations, determining 226 the strength of the affected relations, and correlating 228 the amount of data drift with the threshold values for such changes in the respective relations.

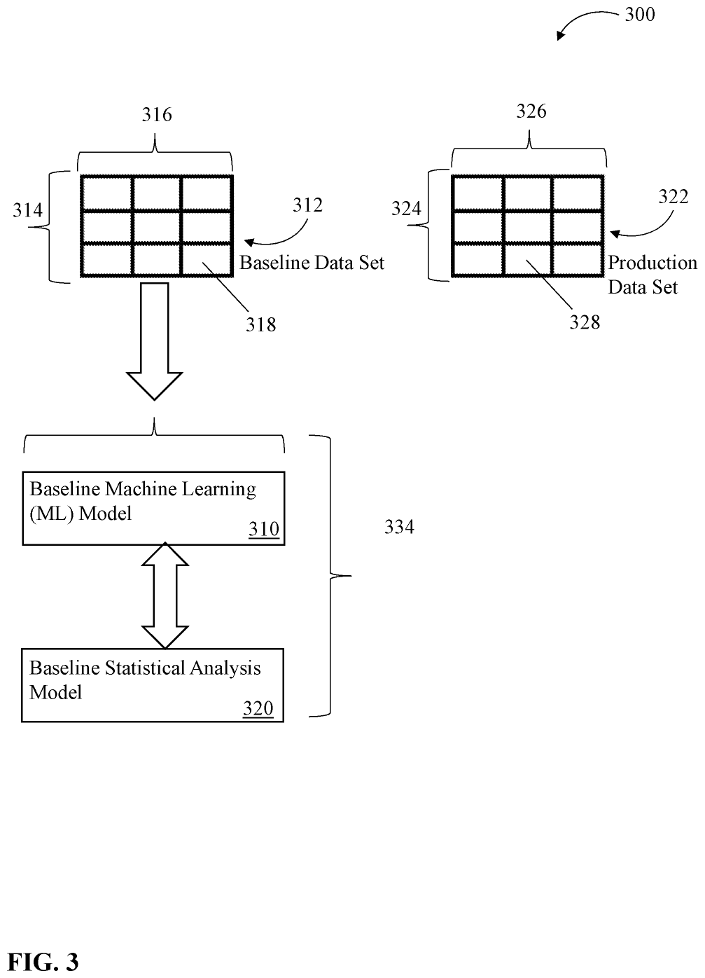

Referring to FIG. 4, a graphical diagram is presented illustrating a behavior 400 of a Bayes Factor as a function of a percentage (p) of data alteration for a first use case, in accordance with some embodiments of the present disclosure. The behavior graph 400 for the first use case is based on altering data representative of rainfall in Australia. The processes described herein are not affected by the nature of the data. The behavior graph 400 includes a Y-axis 402 that represents the calculated Bayes Factor extending from 0 to 9. The behavior graph 400 also includes an X-axis 404 that represents the fixed percentage “p” of the data in a particular column of the production data set that was altered with respect to the respective records through a set of values for p ranging from 0 (no data alteration) and 1 (respective column data for all records altered) to generate a series of altered data sets 322. The Bayes Factor was calculated for each instance of analysis to generate the Bayes Factor behavior cure 406. As shown, the Bayes Factor changes rapidly, i.e., trends upward as the value of p increases from 0 to approximately 0.4, trends upward more moderately from approximately 0.4 to approximately 0.75, and the trend substantially flattens out above approximately 0.75. Accordingly, the rainfall in Australia has one or more strong relations in the associated data set.

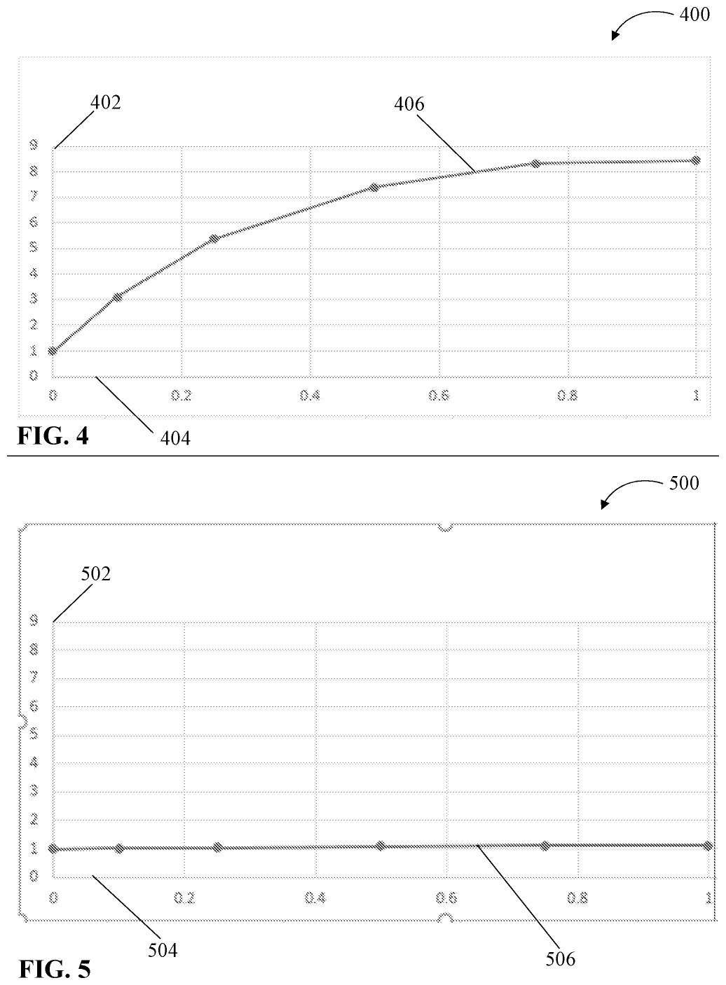

Referring to FIG. 5, a graphical diagram is presented illustrating a behavior 500 of a Bayes Factor as a function of a percentage (p) of data altering for a second use case, in accordance with some embodiments of the present disclosure. The behavior graph 500 for the second use case is based on altering data representative of bike rentals in London, United Kingdom. The processes described herein are not affected by the nature of the data. The behavior graph 500 includes a Y-axis 502 that represents the calculated Bayes Factor extending from 0 to 9. The behavior graph 500 also includes an X-axis 504 that represents the fixed percentage “p” of the data in a particular column of the production data set that was altered with respect to the respective records through a set of values for p ranging from 0 (no data altered) and 1 (respective column data for all records altered) to generate a series of altered data sets. The Bayes Factor was calculated for each instance of analysis to generate the Bayes Factor behavior cure 506. As shown, the behavior of the Bayes Factor is for the value to consistently be approximately unity, thereby defining a substantially flat trend, to indicate that changing the percentage of the alterations has no effect on the altered production data set as compared to the static baseline data set. Accordingly, the bike rentals in London have one or more weak relations in the associated data set.

The system, computer program product, and method as disclosed and described herein are configured for automatic detection of data quality issues, and, more specifically, to automatic detection of changes in data set relations. For at least some of embodiments described herein, the system, computer program product, and method disclosed are configured for automatically determining the influence of changes to the relations in the data sets through data drift. Furthermore, the system, computer program product, and method disclosed herein are configured to subsequently automatically select those relations that are effective in detecting the changes to the data set of interest that may have been introduced through the aforementioned data drift. More specifically, many of the embodiments described herein are configured to determine the relative strength of the affected relations such that those relations with stronger relations may receive more analytical scrutiny than those relatively weak relations. Accordingly, the relations which are determined as strong will be helpful for identifying the changes in the data set.

Therefore, the embodiments disclosed herein provide an improvement to computer technology. For example, the real-time data drift detection features as described herein are useful for monitoring large, complicated data sets that have been used over an extended period of time, where the data relations are not always easy to discern, such as, and without limitation, wide-spread domains such as healthcare and finance domains. The data quality issues detection system automates the whole process of identifying the changes in a data set though leveraging the combined power of machine learning and statistical methods to identify these changes to data relations. The solutions to the issues raised through undiagnosed data drift provides real-time detection of data drift through identifying and analyzing changes in the data relations, thereby mitigating any deleterious effects of the decrease in data quality.

Moreover, the embodiments described herein are integrated into a practical application through the combination of elements to automatically detect when the data quality of a data set is reduced in real-time as the data set is being utilized, thereby mitigating any deleterious financial business impacts of the data drift. For those embodiments where the data set is used nearly continuously, the data quality issues detection system provides substantially continuous monitoring for data drift that may adversely affect the respective businesses. In addition, the embodiments described herein significantly reduce the reliance on expensive domain experts to identify find degradation of the quality and coherency of the data in the data sets. Moreover, the embodiments described herein facilitate identification of the strength of the respective relations without reliance on domain expertise, thereby enhancing the ability to determine previously unidentified strong relations, as well as allow users to prioritize stronger relations over weaker relations. The strength of the relations is determined through comparison with a previously determined threshold value to accommodate the fact that there are no single thresholds and the associated analyses need to be executed in light of the unique properties of the associated data sets.

Referring now to FIG. 6, a block schematic diagram is provided illustrating a computing system 601 that may be used in implementing one or more of the methods, tools, and modules, and any related functions, described herein (e.g., using one or more processor circuits or computer processors of the computer), in accordance with some embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602-1, 602-2, 602-3, 602-N, herein collectively referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 628 and/or program modules 630 generally perform the functions or methodologies of various embodiments.

It is to be understood that although this disclosure includes a detailed description on cloud computing, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

A cloud computing environment is service oriented with a focus on statelessness, low coupling, modularity, and semantic interoperability. At the heart of cloud computing is an infrastructure that includes a network of interconnected nodes. The system 601 may be employed in a cloud computing environment.

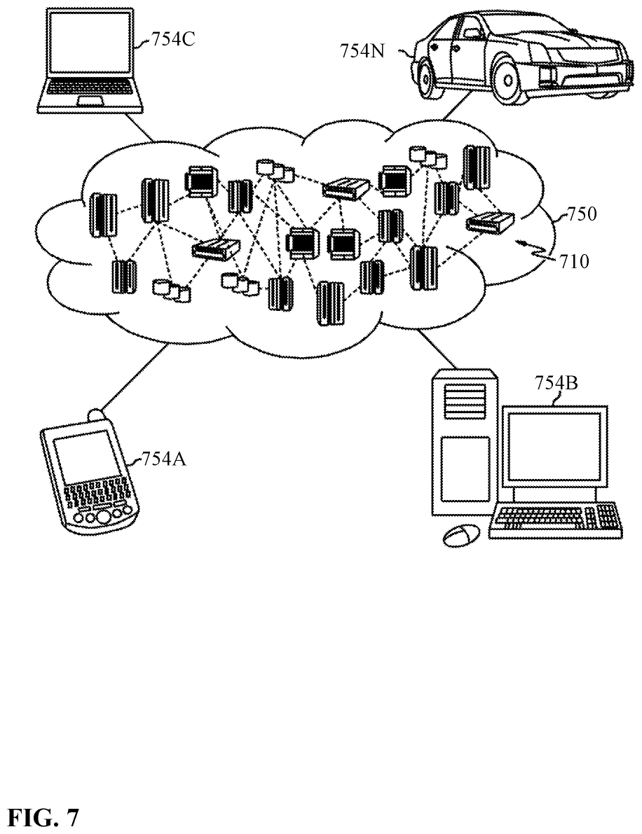

Referring to FIG. 7, a schematic diagram is provided illustrating a cloud computing environment 750, in accordance with some embodiments of the present disclosure. As shown, cloud computing environment 750 comprises one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 710 and cloud computing environment 750 may communicate with any type of computerized device over any type of network and/or network addressable connection (e.g., using a web browser).

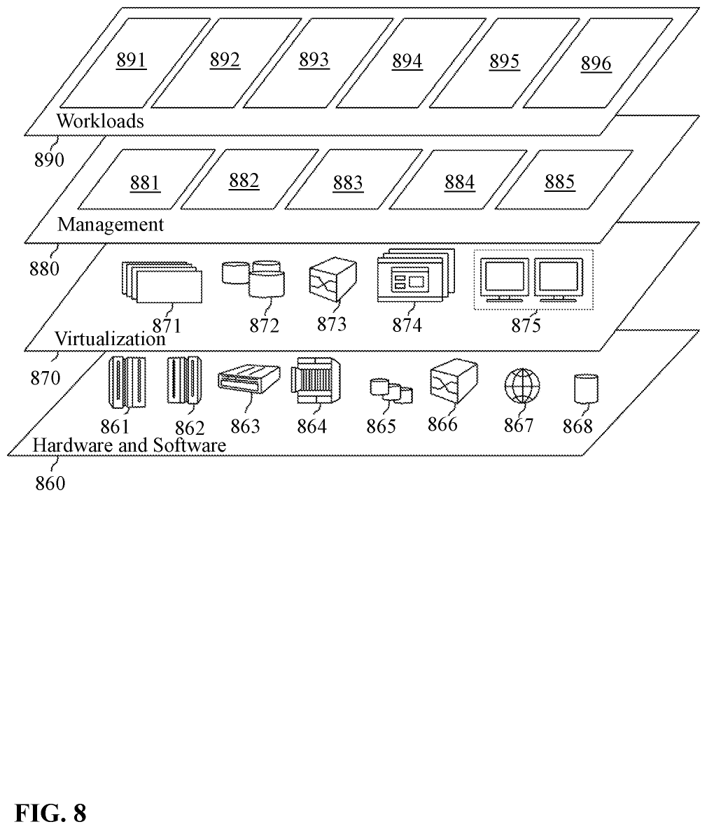

Referring to FIG. 8, a schematic diagram is provided illustrating a set of functional abstraction model layers provided by the cloud computing environment 750 (FIG. 7), in accordance with some embodiments of the present disclosure. It should be understood in advance that the components, layers, and functions shown in FIG. 8 are intended to be illustrative only and embodiments of the disclosure are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: mapping and navigation 891; software development and lifecycle management 892; layout detection 893; data analytics processing 894; transaction processing 895; and automatic detection of changes in data set relations 896.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system for automatic detection of data drift in a baseline data set comprising:
one or more processing devices;
one or more memory devices communicatively and operably coupled to the one or more processing devices;
a data drift determination tool, at least partially resident within the one or more memory devices, configured to determine, in real-time, an indication of one or more changes to one or more relations in the data set, comprising:
provide a production data set, wherein the baseline data set and the production data set are at least partially representative of the same domain, the production data set includes at least some data distortion;
define, for a plurality of participant features in the baseline data set, one or more potential relations;
determine a first likelihood of each potential relation of the one or more potential relations in the baseline data set;
determine, for the participant features, a second likelihood of each potential relation of the one or more potential relations in the production data set;
compare each first likelihood with each second likelihood, thereby generating one or more comparison values;
compare the one or more comparison values with one or more respective threshold values; and
determine, subject to the one or more comparison values exceeding the one or more respective threshold values, the one or more potential relations in the baseline data set do not describe a relation in the production data set.

2. The system of claim 1, wherein the data drift determination tool is further configured to:
determine a relative strength of the one or more potential relations.

3. The system of claim 1, wherein the data drift determination tool is further configured to:
insert the at least some data distortion through alteration of one or more data values in one or more second records of the second plurality of records in the production data set;
vary a percentage of the one or more data values that are altered, thereby generating a plurality of production data sets;
generate a plurality of the one or more comparison values through the respective production data sets; and
determine a relationship between the percentage of the one or more data values that are altered and the generated plurality of comparison values.

4. The system of claim 3, wherein the data drift determination tool is further configured to:
determine the plurality of comparison values indicate one of an increasing trend of the comparison values with an increase of the percentage of the one or more data values that are altered, thereby defining a strong relation; and
determine the plurality of comparison values indicate a substantially flat trend of the comparison values with an increase of the percentage of the one or more data values that are altered, thereby defining a weak relation.

5. The system of claim 3, wherein the data drift determination tool is further configured to:
determine a threshold value for each relation of a plurality of relations within the baseline data set and the production data set, wherein the threshold values for the plurality of relations at least partially define the relative strength of the each relation of the plurality of relations.

6. The system of claim 3, wherein the data drift determination tool is further configured to:
determine, automatically, an influence of changes to each relation of a plurality of relations within the baseline data set and the production data set.

7. The system of claim 6, wherein the data drift determination tool is further configured to:
determine, automatically, those relations of the plurality of relations within the baseline data set and the production data set that are effective in detecting changes to data of interest introduced through data drift.

8. A computer program product embodied on at least one computer readable storage medium having computer executable instructions for automatic detection of data drift in a baseline data set that when executed cause one or more computing devices to:
determine, in real-time, an indication of one or more changes to one or more relations in the baseline data set, comprising:
provide a production data set, wherein the baseline data set and the production data set are at least partially representative of the same domain the production data set includes at least some data distortion;
define, for a plurality of participant features in the baseline data set, one or more potential relations;
determine a first likelihood of each potential relation of the one or more potential relations in the baseline data set;
determine, for the participant features, a second likelihood of each potential relation of the one or more potential relations in the production data set;
compare each first likelihood with each second likelihood, thereby generating one or more comparison values;
compare the one or more comparison values with one or more respective threshold values; and
determine, subject to the one or more comparison values exceeding the one or more respective threshold values, the one or more potential relations in the baseline data set does not describe a relation in the production data set.

9. The computer program product of claim 8, further having computer executable instructions to:
determine a relative strength of the one or more potential relations.

10. The computer program product of claim 8, further having computer executable instructions to:
insert the at least some data distortion through alteration of one or more data values in one or more second records of the second plurality of records in the production data set;
vary a percentage of the one or more data values that are altered, thereby generating a plurality of altered data sets;
generate a plurality of the one or more comparison values through the respective production data sets; and
determine a relationship between the percentage of the one or more data values that are altered and the generated plurality of comparison values.

11. The computer program product of claim 10, further having computer executable instructions to:
determine the plurality of comparison values indicate one of an increasing trend of the comparison values with an increase of the percentage of the one or more data values that are altered, thereby defining a strong relation; and
determine the plurality of comparison values indicate a substantially flat trend of the comparison values with an increase of the percentage of the one or more data values that are altered, thereby defining a weak relation.

12. The computer program product of claim 10, further having computer executable instructions to:
determine a threshold value for each relation of a plurality of relations within the baseline data set and the production data set, wherein the threshold values for the plurality of relations at least partially define the relative strength of the each relation of the plurality of relations.

13. The computer program product of claim 10, further having computer executable instructions to:
determine, automatically, an influence of changes to each relation of a plurality of relations within the baseline data set and the production data set; and
determine, automatically, those relations of the plurality of relations within the baseline data set and the production data set that are effective in detecting changes to data of interest introduced through data drift.

14. A computer-implemented method for automatic detection of data drift in a baseline data set comprising:
determining, in real-time, an indication of one or more changes to one or more relations in the baseline data set, comprising:
providing a production data set, wherein the baseline data set and the production data set are at least partially representative of the same domain the production data set includes at least some data distortion;
defining, for a plurality of participant features in the baseline data set, one or more potential relations;
determining a first likelihood of each potential relation of the one or more potential relations in the baseline data set;
determining, for the participant features, a second likelihood of each potential relation of the one or more potential relations in the production data set;
comparing each first likelihood with each second likelihood, thereby generating one or more comparison values;
comparing the one or more comparison values with one or more respective threshold values; and
determining, subject to the one or more comparison values exceeding the one or more respective threshold values, the one or more potential relations in the baseline data set do not describe a relation in the production data set.

15. The method of claim 14, further comprising:
determining a relative strength of the one or more potential relations.

16. The method of claim 14, wherein the determining the relative strength of the potential relation comprises:
inserting the at least some data distortion comprising altering one or more data values in one or more second records of the second plurality of records in the production data set;
varying a percentage of the one or more data values that are altered, thereby generating a plurality of production data sets;
generating a plurality of the one or more comparison values through the respective production data sets; and
determining a relationship between the percentage of the one or more data values that are altered and the generated plurality of comparison values.

17. The method of claim 16, wherein the determining the relative strength of the potential relation further comprises one of:
determining the plurality of comparison values indicate one of an increasing trend of the comparison values with an increase of the percentage of the one or more data values that are altered, thereby defining a strong relation; and
determining the plurality of comparison values indicate a substantially flat trend of the comparison values with an increase of the percentage of the one or more data values that are altered, thereby defining a weak relation.

18. The method of claim 16, wherein the determining the relative strength of the potential relation further comprises:
determining a threshold value for each relation of a plurality of relations within the baseline data set and the production data set, wherein the threshold values for the plurality of relations at least partially define the relative strength of the each relation of the plurality of relations.

19. The method of claim 16, wherein the determining the relative strength of the potential relation further comprises:
determining, automatically, an influence of changes to each relation of a plurality of relations within the baseline data set and the production data set.

20. The method of claim 19, wherein further comprising:
determining, automatically, those relations of the plurality of relations within the baseline data set and the production data set that are effective in detecting changes to data of interest introduced through data drift.
